(19) United States
(12) Patent Application Publication
(10) Pub. No.: US 2006/0023079 A1
(43) Pub. Date: Feb. 2, 2006

(54) Interface device and synchronization adjustment method

(76) Inventor: Takayuki Sugitani, Osaka (JP)

Correspondence Address: CANTOR COLBURN, LLP, 55 GRIFFIN ROAD SOUTH, BLOOMFIELD, CT, 06002, US

(21) Appl. No.: 11/194,150

(22) Filed: Aug. 1, 2005

(30) Foreign Application Priority Data
Jul. 30, 2004 (JP) JP2004-224649

(51) Int. Cl. H04N 5/228

(52) U.S. Cl. 348/222.1

(57) ABSTRACT

An interface device is equipped with a switching control circuit for acquiring a phase difference between an acquisition synchronization signal having a predetermined period including an effective period and a blanking period and a transmission synchronization signal having a period different from that of the acquisition synchronization signal, the different period including an effective period and a blanking period, the switching control circuit correcting the phase difference between the acquisition synchronization signal and the transmission synchronization signal by changing the blanking period of the transmission synchronization signal. Appropriate synchronization between the acquisition of an image and the transmission of an image can be maintained when image data is buffered using the interface device.

### CROSS-REFERENCE TO RELATED APPLICATION

The entire disclosure of Japanese Application No. 2004-224649 including specification, claims, drawings and abstract is incorporated herein by reference.

### BACKGROUND OF THE INVENTION

1. Field of the Invention

The present invention relates to an interface device used when displaying an input image signal on a display device and to a method of synchronization adjustment of an image signal.

2. Description of the Related Art

Known interface devices which receives input image data from a solid state image capturing device, such as a CCD solid state image capturing device or a CMOS solid state image capturing device, are able to perform various types of processing of the input image data to transfer the processed image data to the controller of a display device such as a liquid crystal display (LCD) when an image captured by the solid state image capturing device is displayed using the display device. For example, a camera-equipped cellular phone may comprise an interface device which receives image data acquired by a solid state capturing device and synthesizes an On Screen Display (OSD) including components such as character images, icons indicating the residual quantity of a power source and a receiving state of an electric wave, and menus to output the synthesized OSD to the controller of a display device.

FIG. 9 is a block diagram showing the configuration of an interface device 100 for synthesizing an image acquired by a solid state image capturing device and an on screen image to display the synthesized image and peripheral devices of the interface device 100. The interface device 100 is used by being connected to a solid state image capturing device 200, a main processing device (CPU) 300, an LCD controller 400 and an LCD display device 402. Moreover, the interface device 100 is configured to include a solid state image capturing device interface (I/F) 10, a rate change buffer 12, an H/V scaler 14, a frame buffer circuit 16, a sub OSD buffer circuit 18, an LCD interface (I/F) 20, and a CPU interface (I/F) 28. The interface device 100 may further include a JPEG line buffer 22, a JPEG codec 24, and a code buffer circuit 26.

The solid state image capturing device 200 captures an image by receiving light from outside of the device, and outputs the captured image as an image signal. The solid state image capturing device interface 10 receives the image signal output from the solid state image capturing device 200 to perform the removal of dummy data included in the image signal and the like, and outputs the image signal to the rate change buffer 12. The rate change buffer 12 is equipped with a line buffer, and changes the transmission timing of the original image data from the solid state image capturing device 200 to the timing capable of being processed by the interface device 100. The H/V scaler 14 converts the original image data to an image size matched to the size of the display screen of the LCD connected to the interface device 100. For example, when an image of 1280×1024 pixels is acquired by the solid state image capturing device 200 and the display size of the LCD is 176×220 pixels, the H/V scaler 14 performs the processing of reducing the image size. The original image data which has received the size conversion is outputted to the frame buffer circuit 16. The frame buffer circuit 16 includes a function as a buffer memory for storing and holding the original image data temporarily for displaying the original image on the LCD through the LCD controller 400. Moreover, when the frame buffer circuit 16 receives an instruction signal from the CPU 300 through the CPU I/F 28, the frame buffer circuit 16 generates decorative composite image data by superposing the original image data acquired by the solid state image capturing device 200 on decorative image data (or sub-image data) prepared in advance, or by performing some processes such as the rotation of image data. The generated decorative composite image data is output to the sub OSD buffer circuit 18. When the sub OSD buffer circuit 18 receives an instruction signal from the CPU 300 through the CPU I/F 28, the sub OSD buffer circuit generates image data for display by synthesizing decorate composite image data with OSD image data such as icons indicating the residual quantity of the power source and the state of receiving an electric wave.

The LCD controller 400 comprises a memory for images. The LCD controller 400 reads image data for display held in the sub OSD buffer circuit 18 to store and save the read image data for display in the memory for images temporarily. Then, the LCD controller 400 reads image data stored in the memory for images at a predetermined period (e.g. 60 Hz) in response to a transmission synchronization signal V_{ACT} to transfer the read image data to the LCD display device 402 sequentially. Thereby, an image is displayed on the screen of the LCD display device 402.

Moreover, when the JPEG line buffer 22 receives full size original image data from the rate change buffer 12, resized original image data from the H/V scaler 14, or decorative composite image data from the frame buffer circuit 16, the JPEG line buffer 22 holds the received image data until the end of the compression processing of a JPEG format in the JPEG codec 24. The JPEG codec 24 reads the image data held in the JPEG line buffer 22, and performs compression processing of the JPEG format. The JPEG code generated by the compression processing is temporarily stored and held by the code buffer circuit 26. The CPU 300 reads the JPEG code from the code buffer circuit 26, and causes a juxtaposed memory (not shown) store and hold the read JPEG code. Moreover, it is also possible to transfer the resized original image data to the CPU 300 without performing compression processing to save the transferred resized original data in the memory by transmitting the image data directly from the H/V scaler 14 to the code buffer circuit 26. The image data stored by the JPEG code can also receive the decompression processing in the reverse direction to the processing mentioned above.

In recent years, LCD controllers without a memory for images have become commonly used in order to increase the versatility of the LCD controllers by miniaturizing and simplifying the LCD controllers. Generally, the time necessary for transmitting image data to an LCD controller is shorter than the time necessary for capturing an image in a solid state image capturing device. Accordingly, when an LCD controller having no built-in memory for images is used, it is necessary to continue to transfer image data to an LCD sequentially at every predetermined period until the next one-frame image is captured. Accordingly, it is preferable to provide a frame buffer circuit including frame buffers for two frames on an interface device side, and to perform image processing, holding the image data which is now displayed on a frame buffer for one frame and the image data of the next frame on the other frame buffer for another frame, and further to switch the present frame buffer to the next frame buffer among the two frame buffers after the processing of the present image data has ended to transmit the image data of a new frame to the LCD controller.

In this case, when using an LCD controller without built-in memory for images, it is necessary for the interface device to synchronize the timing of receiving an image signal from the solid state image capturing device with the timing of transmitting image data to the LCD controller.

A timing chart of an acquisition synchronization signal V_{REF} indicating the acquisition timing of an image signal and a transmission synchronization signal V_{ACT} indicating the transmission timing of image data is shown in FIG. 10. The acquisition synchronization signal V_{REF} and the transmission synchronization signal V_{ACT} severally repeat to take a high level and a low level at a predetermined period. The interface device 100 begins receiving an image signal from the solid state image capturing device 200 in response to a rise of the acquisition synchronization signal V_{REF}, and continues to receive the image signal from the solid state image capturing device 200 for a period during which the acquisition synchronization signal V_{REF} maintains the high level. Moreover, the interface device 100 starts to transmit image data to the LCD controller 400 in response to a rise of the transmission synchronization signal V_{ACT}, and the interface device 100 continues to transmit the image data for a period during which the transmission synchronization signal V_{ACT} maintains the high level. The frame rate of the acquisition synchronization signal V_{REF} is normally set to an integral multiple of the frame rate of the transmission synchronization signal V_{ACT}.

However, at the time of acquiring an image using an image capturing apparatus such as a camera equipped with a solid state image capturing device, the timing of a start of image capturing is generally entrusted to a user, and it is impossible to control the timing of the start of the image capturing. Consequently, it is sometimes impossible to switch the frame buffers at a time when a period in which the acquisition synchronization signal V_{REF} does not rise (blanking period) and a period in which the transmission synchronization signal V_{ACT} do not rise in accordance with each other.

When the frame buffers are switched in the state in which the synchronization of rises of the acquisition synchronization signal V_{REF} and the transmission synchronization signal V_{ACT} is not acquired, there is the possibility that the image data transmitted to the LCD controller is switched in the middle of a frame of the image the image data of which is displayed to make the display image of the LCD is disordered. Furthermore, the reading operations of the image data from the frame buffers are not ensured at the time point when the frame buffers are switched, and there is also the possibility that the image data held in the frame buffers will be damaged or lost.

### SUMMARY OF THE INVENTION

According to the present invention, an interface device for acquiring an image signal in an effective period of an acquisition synchronization signal having a predetermined period including the effective period and a blanking period in synchronization with the acquisition synchronization signal, and for outputing image data for display in an effective period of a transmission synchronization signal having a period different from that of the acquisition synchronization signal, the different period including the effective period and a blanking period, in synchronization with the transmission synchronization signal, wherein the interface device acquires a phase difference between the acquisition synchronization signal and the transmission synchronization signal, and corrects the phase difference between the acquisition synchronization signal and the transmission synchronization signal by changing the blanking period of the transmission synchronization signal.

According to another aspect of the present invention, an interface device for acquiring an image signal in an effective period of an acquisition synchronization signal having a predetermined period including the effective period and a blanking period in synchronization with the acquisition synchronization signal, and for outputing image data for display in an effective period of a transmission synchronization signal having a period different from that of the acquisition synchronization signal, the different period including the effective period and a blanking period, in synchronization with the transmission synchronization signal, wherein the interface device starts the blanking period of the transmission synchronization signal, the blanking period of the transmission synchronization signal being for a predetermined time, at an end time point of the effective period of the acquisition synchronization signal.

According to a further aspect of the present invention, an interface device for acquiring an image signal in an effective period of an acquisition synchronization signal having a predetermined period including the effective period and a blanking period in synchronization with the acquisition synchronization signal, and for outputing image data for display in an effective period of a transmission synchronization signal having a period different from that of the acquisition synchronization signal, the different period including the effective period and a blanking period, in synchronization with the transmission synchronization signal, wherein the interface device judges whether the effective period of the transmission synchronization signal ends during a predetermined waiting time from an end time point of the effective period of the acquisition synchronization signal, and starts the blanking period of the transmission synchronization signal, the blanking period of the transmission synchronization signal being for a predetermined time, when the effective period of the transmission synchronization signal does not end within the waiting time.

According to a still further aspect of the present invention, a synchronization adjustment method acquires an image signal in an effective period of an acquisition synchronization signal having a predetermined period including the effective period and a blanking period in synchronization with the acquisition synchronization signal, and outputs image data for display in an effective period of a transmission synchronization signal having a period different from that of the acquisition synchronization signal, the different period including the effective period and a blanking period, in synchronization with the transmission synchronization signal, and further the method includes a first step of correcting a phase difference between the acquisition synchronization signal and the transmission synchronization signal by changing the blanking period of the transmission synchronization signal.

According to a still further aspect of the present invention, a synchronization adjustment method acquires an image signal in an effective period of an acquisition synchronization signal having a predetermined period including the effective period and a blanking period in synchronization with the acquisition synchronization signal, and outputs image data for display in an effective period of a transmission synchronization signal having a period different from that of the acquisition synchronization signal, the different period including the effective period and a blanking period, in synchronization with the transmission synchronization signal, wherein the method starts the blanking period of the transmission synchronization signal, the blanking period of the transmission synchronization signal being for a predetermined time, at an end time point of the effective period of the acquisition synchronization signal.

According to a still further aspect of the present invention, a synchronization adjustment method acquires an image signal in an effective period of an acquisition synchronization signal having a predetermined period including the effective period and a blanking period in synchronization with the acquisition synchronization signal, and outputs image data for display in an effective period of a transmission synchronization signal having a period different from that of the acquisition synchronization signal, the different period including an effective period and a blanking period, in synchronization with the transmission synchronization signal, wherein the method judges whether the effective period of the transmission synchronization signal ends during a predetermined waiting time from an end time point of the effective period of the acquisition synchronization signal, and starts the blanking period of the transmission synchronization signal, the blanking period of the transmission synchronization signal being for a predetermined time, when the effective period of the transmission synchronization signal does not end within the waiting time.

### BRIEF DESCRIPTION OF THE DRAWINGS

Preferred embodiments of the present invention will be described in further detail based on the following drawings wherein:

FIG. 1 is a diagram showing the configuration of an image processing apparatus according to an embodiment of the present invention;

FIG. 2 is a diagram showing a timing chart in a first control method of the present invention;

FIG. 3 is another diagram showing a timing chart in the first control method of the present invention;

FIG. 4 is a diagram showing the configuration of a switching control circuit used for a second control method of the present invention;

FIG. 5 is a flowchart of the second control method of the present invention;

FIG. 6 is a diagram showing phase shifts of synchronization signals;

FIG. 7 is another diagram showing a phase shift of synchronization signals;

FIG. 8 is a diagram showing a flowchart of a modified example of the second control method of the present invention;

FIG. 9 is a diagram showing the configuration of a conventional image processing apparatus; and

FIG. 10 is a diagram showing a timing chart of synchronization signals.

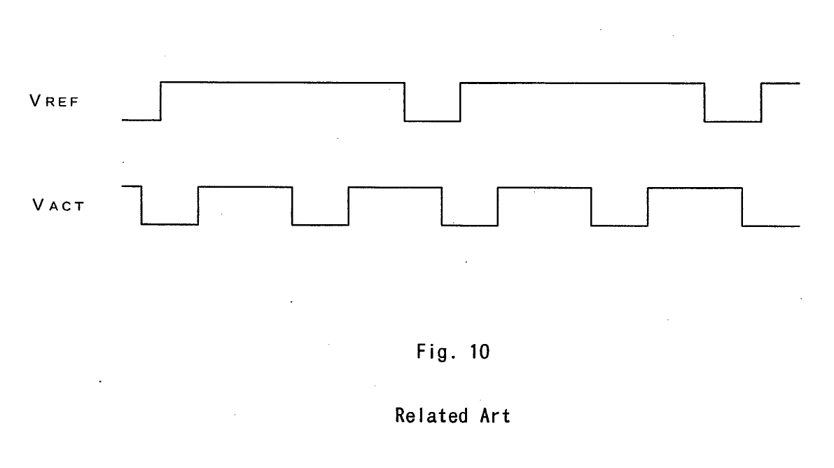

### DETAILED DESCRIPTION OF THE PREFERRED EMBODIMENTS

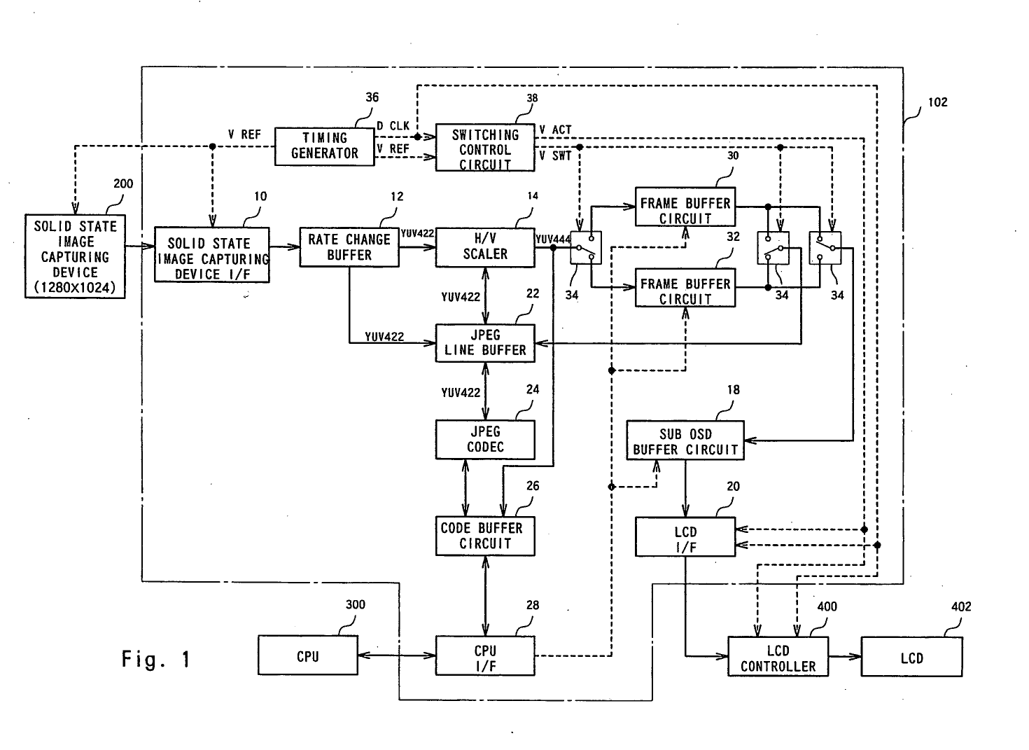

An interface device 102 according to an embodiment of the present invention is, as shown in FIG. 1, connectable to the solid state image capturing device 200, the main processing device (CPU) 300, the LCD controller 400 and the LCD display device 402. The interface device 102 is configured to include the solid state image capturing device interface (I/F) 10, the rate change buffer 12, the H/V scaler 14, the sub OSD buffer circuit 18, the LCD interface (I/F) 20, the CPU interface (I/F) 28, a first frame buffer circuit 30, a second frame buffer circuit 32, switching circuits 34, a timing generator 36 and a switching control circuit 38. Moreover, the interface device 102 may further include the JPEG line buffer 22, the JPEG codec 24 and the code buffer circuit 26. In FIG. 1, components having the same functions as those of the related art described above are denoted by the same reference characters.

The solid state image capturing device 200 can be configured to include a CCD solid state image capturing device, a CMOS solid state image capturing device and the like, and a controller or the like. The solid state image capturing device 200 is configured to include light receiving pixels arranged in a matrix. The light receiving pixels receive light from outside of the devices to generate information electric charges according to the intensity of the received light. The solid state image capturing device 200 outputs an image signal having the intensity according to the information electric charge quantity generated by each light receiving pixel to the solid state image capturing device I/F 10. When the solid state image capturing device 200 receives an acquisition synchronization signal V_{REF} generated by the timing generator 36 installed in the interface device 102, the solid state image capturing device 200 starts capturing of an image of a new frame in synchronization with a rise of the acquisition synchronization signal V_{REF}, and sequentially outputs image signals during an effective period in which the acquisition synchronization signal V_{REF} maintains a high level.

The solid state image capturing device interface 10 receives the image signals output from the solid state image capturing device 200. When the solid state image capturing device interface 10 receives the acquisition synchronization signal V_{REF} generated by the timing generator 36, the solid state image capturing device interface 10 performs the reception processing on the image signals in synchronization with the outputs of the image signals from the solid state image capturing device 200. That is, the solid state image capturing device interface 10 starts capturing the image signals of a new frame in synchronization with the acquisition synchronization signal V_{REF}, and sequentially receives the image signals for one frame from the solid state image capturing device 200 during the effective period in which the acquisition synchronization signal V_{REF} maintains the high level. Moreover, the solid state image capturing device interface 10 performs the removal of dummy data included in the image signals and the like, and outputs the image signals to the rate change buffer 12 as original image data. The original image data can be the image data of, for example, the YUV 422 format.

The rate change buffer 12 is equipped with a line buffer, and changes the transmission timing of the original image data from the solid state image capturing device 200 to the timing capable of being processed by the interface device 100. The H/V scaler 14 converts the original image data to an image size matched with the size of the display screen of the LCD connected to the interface device 102. Existing interpolation processing or the like can be used for the conversion of the image sizes. The original image data which has received the size conversion is output to the frame buffer circuits 30 and 32.

The frame buffer circuits 30 and 32 are severally equipped with a memory for storing and holding the original image data temporarily. The frame buffer circuits 30 and 32 perform the temporary buffering of the original image data for displaying the original image on the LCD display device 402. Moreover, the frame buffer circuits 30 and 32 also perform the function as buffer memories for performing the working processing of the original image data. When the frame buffer circuits 30 and 32 receive an instruction signal from the CPU 300 through the CPU I/F 28, the frame buffer circuits 30 and 32 severally perform various types of working processing on the original image data captured from the solid state image capturing device 200 to generate decorative composite image data. For example, the frame buffer circuits 30 and 32 perform the addition synthesis of the original image data with decorative image data prepared in advance, weighting each of them. Alternatively, the frame buffer circuits 30 and 32 severally perform the some processes such as the rotation of the image data. As examples of decorative image data means, the image data of a frame image fringing the original image data, a character image superposed in the original image data, and the like can be used. Such decorative image data is previously stored and held in an image memory built in the frame buffer circuit 30 or in an image memory juxtaposed to the CPU 300, and can be read from the frame buffer memory 30 to be used as required. The generated decorative composite image data is output to the JPEG line buffer 22 and the sub OSD buffer circuit 18.

The input and the output to and from the frame buffer circuits 30 and 32 are switched by the switching circuits 34 and the switching control circuit 38. The switching of the switching circuits 34 is performed in response to a switching signal V_{SWT} output from the switching control circuit 38, and the input of either of the frame buffer circuits 30 and 32 is connected to the H/V scaler 14. Moreover, the output of either of the frame buffer circuits 30 and 32 is connected to the JPEG line buffer 22, and the output of the other one is connected to the sub OSD buffer circuit 18. In such a case, the switching circuits 34 are switched so that either of the frame buffer circuits 30 and 32 receives an input from the H/V scaler 14 and at the same time performs output to the JPEG line buffer 22. Moreover, either of the frame buffers 30 and 32 is not connected to the H/V scaler 14, and the output thereof is connected to the sub OSC buffer circuit 18. Although example switching circuits 34 are shown in FIG. 1 as conceptual switching circuits, the actual configurations are not limited to the illustrated examples.

For example, when the output of the frame buffer circuit 30 is connected to the sub OSD buffer circuit 18, the input of the frame buffer circuit 32 is connected to the H/V scaler 14, and, at the same time, the output of the frame buffer circuit 32 is connected to the JPEG line buffer 22. In such a case, when the frame buffer circuit 32 receives the image data from the H/V scaler 14, the frame buffer circuit 32 sequentially stores the received image data into the buffer memory. At the same time, the frame buffer circuit 32 performs the some processes of the image data based on the instruction signal from the CPU 300. Moreover, the frame buffer circuit 32 outputs the worked image data to the JPEG line buffer 22, and the compression processing of the image data is performed in the JPEG codec 24. On the other hand, the frame buffer circuit 30 is not connected to the H/V scaler 14, and outputs the image date stored in the buffer memory to the sub OSD buffer circuit 18. At the point when the buffering of the image data for one frame has newly ended and the working processing and the compression processing of the image data has ended in the frame buffer circuit 32, the switching circuits 34 are switched based on the switching signal V_{SWT}. Thereby, the connection destinations of the inputs and the outputs of the frame buffer circuits 30 and 32 are switched. The generation of the switching signal in the switching control circuit 38 will be described later.

In the present example, the switching control circuit 38 is a circuit equipped with an edge detection circuit detecting a change of the acquisition synchronization signal V_{REF} and a change of the transmission synchronization signal V_{ACT}, a phase difference counting circuit acquiring a phase difference between the acquisition synchronization signal V_{REF} and the transmission synchronization signal V_{ACT} based on detection results of the changes of the acquisition synchronization signal V_{REF} and the transmission synchronization signal V_{ACT} in the edge detection circuit, and a synchronization signal correcting circuit correcting the phase difference between the acquisition synchronization signal V_{REF} and the transmission synchronization signal V_{ACT} by increasing and decreasing (or increasing) the blanking period of the transmission synchronization signal V_{ACT} based on the phase difference between the acquisition synchronization signal V_{REF} and the transmission synchronization signal V_{ACT} both obtained by the phase difference counting circuit.

When the sub OSD buffer circuit 18 receives an instruction signal from the CPU 300 through the CPU I/F 28, the sub OSD buffer circuit 18 generates image data for display by synthesizing decorate composite image data with on screen image data based on the instruction signal. Incidentally, the on screen image data can be set as image data pertaining to the control of electric equipment and the state indication thereof such as icons and menus indicating the residual quantity of the power source and the state of receiving an electric wave. However, the on screen image data is not limited to the items mentioned above. Such on screen image data is previously stored and held in an image memory built in the sub OSD buffer circuit 18 or an image memory juxtaposed to the CPU 300, and is read from the sub OSD buffer circuit 18 to be used as the need arises.

The image data for display generated by the sub OSD buffer circuit 18 is read by the LCD controller 400 through the LCD I/F 20, and is transferred to the LCD display device 402. To put it concretely, the LCD I/F 20 and the LCD controller 400 severally receive an image transfer clock D_{CLK} and the transmission synchronization signal V_{ACT} from the timing generator 36 and the switching control circuit 38, respectively, and sequentially transfer the image data for display output from the sub OSD buffer circuit 18 to the LCD display device 402.

The image transfer clock D_{CLK} is a signal for controlling the transmission timing of each data at the time of performing the transfer processing of the image data to the LCD display device 402. The image transfer clock D_{CLK} is generated by the timing generator 36. The transmission synchronization signal V_{ACT} is a signal indicating the start timing of a frame at the time of displaying an image on the LCD display device 402. The transmission synchronization signal V_{ACT} is a pulse-like signal repeating a combination of an effective period of a high level and a blanking period of a low level. In the present embodiment, the image data for one frame is transferred in an effective period taking the high level. Here, the transmission synchronization signal V_{ACT} is generated by the switching control circuit 38.

The LCD controller 400 in the present embodiment is not provided with any installed memory for buffering image data. Therefore, the LCD controller 400 reads the image data for display in the sub OSD buffer circuit 18, which image data is the processed image data held in either of the frame buffer circuits 30 and 32, through the LCD I/F 20 in synchronization with a rise of the transmission synchronization signal V_{ACT} in an effective period thereof, and the LCD controller 400 sequentially transmits the image data for display to the LCD display device 402 in synchronization with the image transfer clock D_{CLK}. Thereby, the LCD display device 402 is sequentially updated by the image data for display, and an image is displayed on the LCD display device 402. That is, a plurality of frame buffer circuits 30 and 32 are provided in order to hold image data for at least two frames, and the image is output from one of the frame buffer circuits 30 and 32. Thereby, it is possible to display images without installing any buffer memories in the LCD controller 400, although it is necessary to synchronize the acquisition synchronization signal V_{REF} with the transmission synchronization signal V_{ACT}. An example synchronization adjustment method will be described below, together with the switching processing of the switching control circuit 38 and the switching circuit 34.

In the present embodiment, the interface device 102 may be provided with the JPEG line buffer 22, the JPEG codec 24 and the code buffer circuit 26. In this case, image data can be stored in an external memory in a compressed state or a not compressed state.

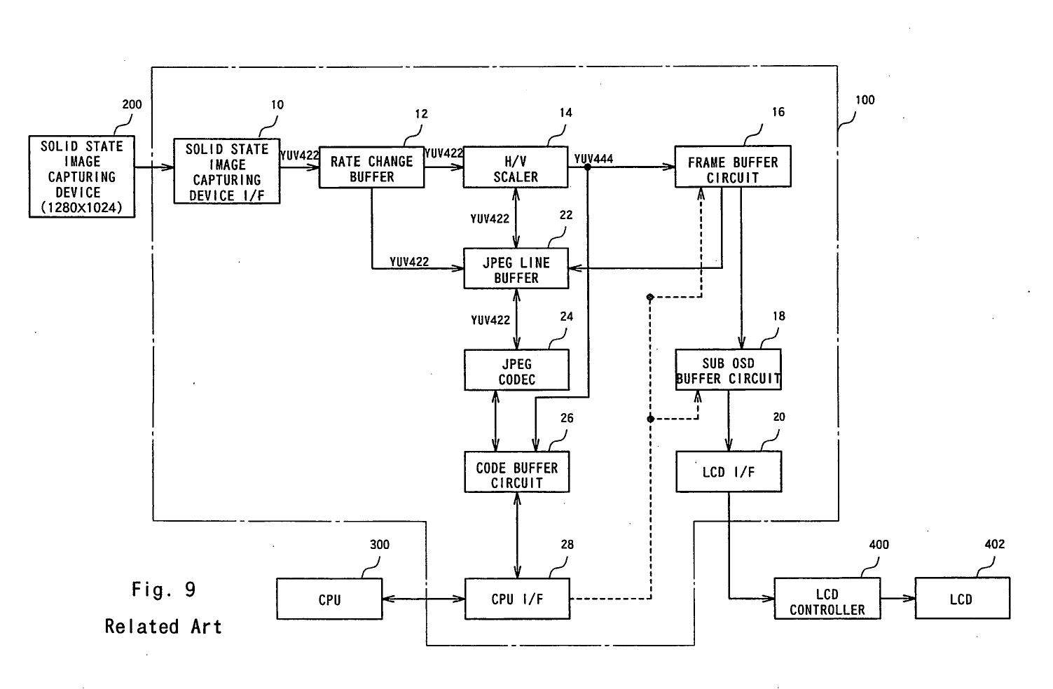

The JPEG line buffer 22 receives full size original image data from the rate change buffer 12, resized original image data from the H/V scaler 14, or decorative composite image data from the frame buffer circuit 30 or 32, and holds the received image data until the end of the processing of the JPEG codec 24. It is preferable to adopt a configuration capable of selecting which image data is held by the JPEG line buffer 22 with a control signal from the CPU 300. The JPEG codec 24, the code buffer circuit 26 and the CPU 300 severally has the same functions as those of the configuration portions denoted by the same reference characters in FIG. 9.

When the CPU 300 receives the designation of image data to be displayed from a user, the CPU 300 reads the image data which is stored in the external memory and is expressed by JPEG codes, and transfers the read image data to the code buffer circuit 26 through the CPU I/F 28. When the JPEG codec 24 receives an instruction signal of decompression processing from the CPU 300, the JPEG codec 24 performs the decompression processing of the JPEG codes buffered in the code buffer circuit 26 on the image data of bit map format or the like. The image data having received the decompression processing is transferred to the H/V scaler 14 through the JPEG line buffer 22. In the H/V scaler 14, the image size of the image data is converted as the need arises, and the converted image data is output to the frame buffer circuit 30 or 32. Thereby, the image data stored in the external memory can be displayed on the LCD display device 402.

Next, examples of the generation of the transmission synchronization signal V_{ACT} and the switching signal V_{SWT} and the synchronization adjustment of the transmission synchronization signal V_{ACT} and the acquisition synchronization signal V_{REF} in the switching control circuit 38 will be described.

<First Control Method>

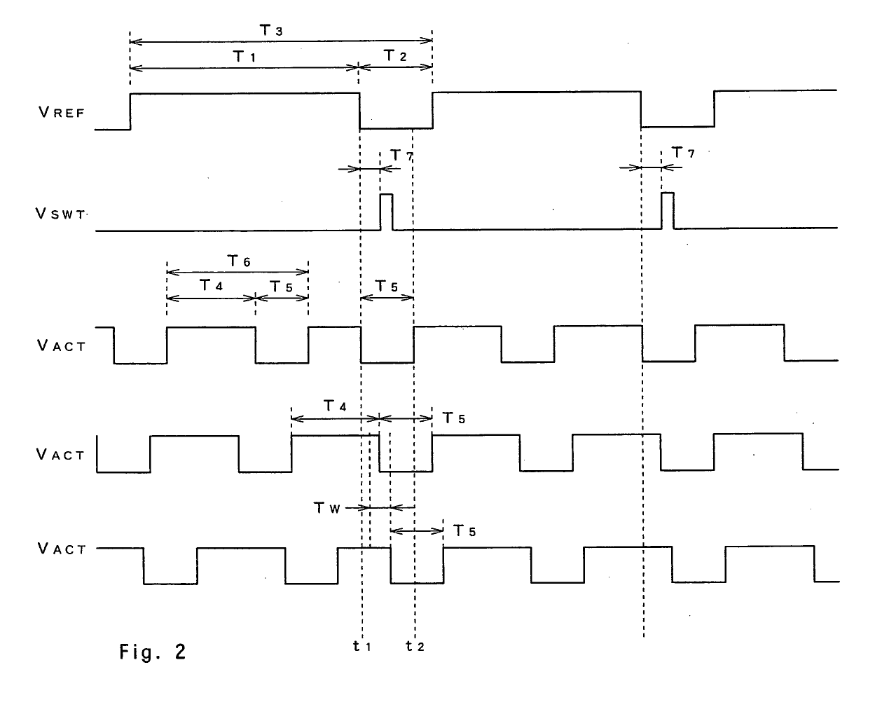

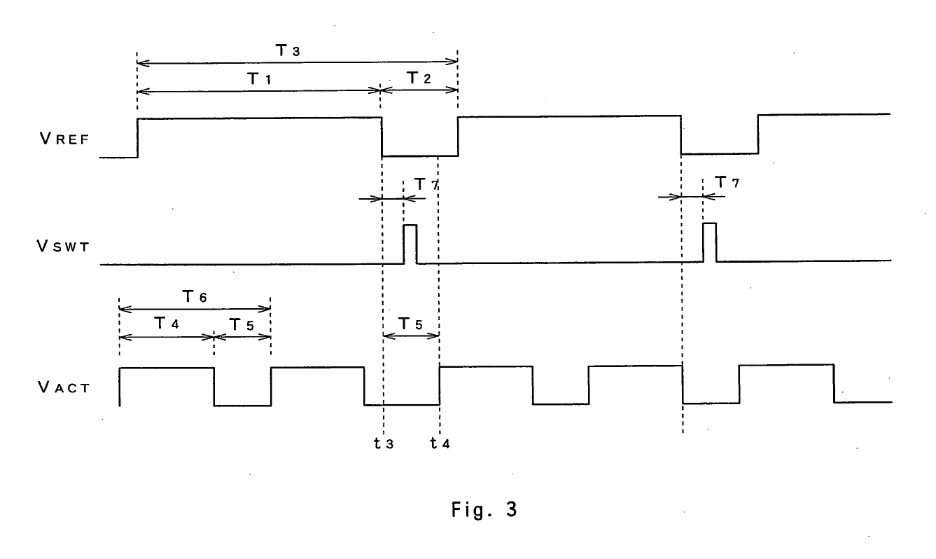

In a first control method, the switching control of the inputs and the outputs of the frame buffer circuits 30 and 32 is preformed in synchronization with the end time point of the buffering of the image signals for a new frame. FIGS. 2 and 3 show timing charts of respective signals in the case where the first control method is applied. In FIGS. 2 and 3, the abscissa axes indicate time, and the ordinate axes indicate the amplitudes of signals.

When the timing generator 36 receives a basic clock of the system, the timing generator 36 generates the image transfer clock D_{CLK} and the acquisition synchronization signal V_{REF} based on the received basic clock. The image transfer clock D_{CLK} can be generated by performing the frequency division of the basic clock by a frequency dividing circuit or the like.

The acquisition synchronization signal V_{REF} is generated by operations of the power switch, the shutter control, and the like by a user. The CPU 300 transmits a signal instructing the generation starting of the acquisition synchronization signal V_{REF} to the timing generator 36 based on a user's operation of the image capturing device or the like. When the timing generator 36 receives the instruction signal from the CPU 300, the timing generator 36 generates the acquisition synchronization signal V_{REF} as shown in FIGS. 2 and 3. The acquisition synchronization signal V_{REF} repeats cycles in each of which the high level is maintained for a predetermined effective time T₁ and the low level is maintained for a predetermined blanking time T₂. That is, the acquisition synchronization signal V_{REF} has a predetermined period T₃ obtained by adding the effective time T₁ and the blanking period T₂.

The acquisition synchronization signal V_{REF} is input to the solid state image capturing device 200 and the solid state image capturing device I/F 10. In the solid state image capturing device 200, an image of a new frame is acquired in synchronization with a rise of the acquisition synchronization signal V_{REF}, and an image signal for one frame is output during a period when the acquisition synchronization signal V_{REF} maintains the high level. In the solid state image capturing device I/F 10, the image signal from the solid state image capturing device 200 is received in synchronization with the acquisition synchronization signal V_{REF}.

The switching control circuit 38 receives the acquisition synchronization signal V_{REF} from the timing generator 36. When the switching control circuit 38 receives the acquisition synchronization signal V_{REF}, the switching control circuit 38 generates the transmission synchronization signal V_{ACT} and the switching signal V_{SWT} based on the acquisition synchronization signal V_{REF}. The switching control circuit 38 generates the transmission synchronization signal V_{ACT}, which is normally made to be high level for a predetermined effective period T₄, and successively made to be low level for a predetermined blanking period T₅.

Generally, because the time for transmitting image data to the LCD controller 400 is shorter than the time necessary for acquiring the image in the solid state image capturing device 200, a period T₆ of the transmission synchronization signal V_{ACT} is set to be shorter than the period T₃ of the acquisition synchronization signal V_{REF}. Moreover, the period T₃ of the acquisition synchronization signal V_{REF} is set to be an integral multiple of the period T₆ of the transmission synchronization signal V_{ACT}. More specifically, the period T₃ of the acquisition synchronization signal V_{REF} is set to be two to five times the period T₆ of the transmission synchronization signal V_{ACT}. Consequently, as shown in FIGS. 2 and 3, the transmission synchronization signal V_{ACT} is repeated by a plurality of times during the period T₃ of the acquisition synchronization signal V_{REF} elapses.

The image transfer clock D_{CLK} output from the timing generator 36 and the transmission synchronization signal V_{ACT} output from the switching control circuit 38 are input into the LCD I/F 20 and the LCD controller 400. As described above, the image data for display is transferred to the LCD display device 402 based on the image transfer clock D_{CLK} and the transmission synchronization signal V_{ACT}, and an image is displayed.

As described above, the interface device 102 causes the LCD display device 402 display the image data held by the frame buffer circuit 30 or 32 through the sub OSD buffer circuit 18, the LCD I/F 20 and the LCD controller 400 in synchronization with the transmission synchronization signal V_{ACT} repeated at the predetermined period T₆. However, when the period of the acquisition synchronization signal V_{REF} is shifted by an operation of a user or the like, a phase difference is generated between the rises of the acquisition synchronization signal V_{REF} and the transmission synchronization signal V_{ACT}. Consequently, it is necessary to synchronize the transmission synchronization signal V_{ACT} indicating the display timing of an image and the switching signal V_{SWT} indicating the switching timing of the inputs and the outputs of the frame buffer circuits 30 and 32 with the acquisition synchronization signal V_{REF}.

The inputs and the outputs of the frame buffer circuits 30 and 32 must be switched when the image data for a new frame is transferred from the solid state image capturing device 200 and the buffering, the work processing, and the compression processing of the image data have ended. The switching control circuit 38 generates, as shown in FIGS. 2 and 3, switching signals V_{SWT}, each having a pulse rising after a predetermined waiting time T₇ has elapsed from the time point when the acquisition synchronization signal V_{REF} has changed from the high level to the low level, specifically the time point when the image signal for one frame has been buffered from the solid state image capturing device 200. The switching signals V_{SWT} are output to the switching circuits 34. When the switching circuits 34 receive the switching signals V_{SWT} from the switching control circuit 38, the switching circuits 34 switch the inputs and the outputs of the frame buffer circuits 30 and 32. At this time, as described above, the switching of the switching circuits 34 is performed so that the input of either of the buffer circuits 30 and 32 may be complementarily connected to the H/V scaler 14. Moreover, the switching of the switching circuit 34 is performed so that the output of either of the frame buffer circuits 30 and 32 may be connected to the JPEG line buffer 22, and that the other output may be connected to the sub OSD buffer circuit 18.

For example, when the switching signal V_{SWT} is newly raised in the state in which the output of the frame buffer circuit 30 is connected to the sub OSD buffer circuit 18 and the input and output of the frame buffer circuit 32 are connected to the H/V scaler 14 and the JPEG line buffer 22, respectively, the switching circuits 34 are switched in order that the input and the output of the frame buffer circuit 30 are connected to the H/V scaler 14 and the JPEG line buffer 22, respectively, and the output of the frame buffer circuit 32 is connected to the sub OSD buffer circuit 18.

At this point, it is suitable to set the waiting time T₇ to a period longer than the period of time of from the end of the buffering of image data to the ends of the working processing and the compression processing of the image data. For example, it is suitable to adopt a configuration of receiving a control signal indicating the end of the compression processing of image data for one frame from the JPEG codec 24, and of raising the switching signal V_{SWT} at the time point of receiving the control signal. Thereby, the connection states of the inputs and the outputs of the frame buffer circuits 30 and 32 are maintained during the period of time of from the end of the buffering of image data to the ends of the working processing and the compression processing of the image data, and the working processing or the compression processing can be reliably executed.

Moreover, the switching control circuit 38 verifies whether the transmission synchronization signal V_{ACT} is at the high level or the low level at the time point when the acquisition synchronization signal V_{REF} changes from the high level to the low level.

As shown in FIG. 2, when the transmission synchronization signal V_{ACT} is at the high level at the time t₁ when the acquisition synchronization signal V_{REF} changes from the high level to the low level, the transmission synchronization signal V_{ACT} is immediately made low level as shown at a third step in FIG. 2. Then, at the time t₂ when the blanking time T₅ has elapsed, the transmission synchronization signal V_{ACT} is raised to the high level. At this time, the time necessary for transmitting the image data to the LCD controller 400 is generally shorter than the time of acquiring an image in the solid state image capturing device 200, and the period T₃ of the acquisition synchronization signal V_{REF} is set to be two to five times the period T₆ of the transmission synchronization signal V_{ACT}. Consequently, even if the transmission synchronization signal V_{ACT} is newly synchronized in the state in which the transmission synchronization signal V_{ACT} is at the high level, namely in the state in which the display processing of the LCD display device 402 is in the middle of a frame, the possibility that the displayed image on the LCD display device 402 is disordered is slim because the possibility that the display of the image data for display having the same period as the preceding period of the transmission synchronization signal V_{ACT} is being performed is strong.

Moreover, as a modified example of the present embodiment, it is also suitable delay the changing of the transmission synchronization signal V_{ACT} to the low level until after a predetermined waiting period T_{W} elapses after detecting the end of the buffering of new image data and the ends of the working processing and the compression processing of the image data, and to verify whether or not the transmission synchronization signal V_{ACT} is in the blanking period during the waiting time T_{W}, and further to synchronize, if possible, the transmission synchronization signal V_{ACT} with the acquisition synchronization signal V_{REF} when the transmission synchronization signal V_{ACT} is in the blanking period. As shown at a fourth step of FIG. 2, when the transmission synchronization signal V_{ACT} falls in the waiting period T_{W} to enter the blanking period, the transmission synchronization signal V_{ACT} is raised after the period T₅ has elapsed from the time point when the transmission synchronization signal V_{ACT} falls to the low level. As shown at a fifth step of FIG. 2, when the transmission synchronization signal V_{ACT} does not enter the blanking period within the predetermined period T_{W}, the transmission synchronization signal V_{ACT} is made to fall after the waiting time T_{W} has elapsed so as to enter the blanking time, and the transmission synchronization signal V_{ACT} is raised after the period T₅ has elapsed from the time point when the transmission synchronization signal V_{ACT} has become the low level.

On the other hand, as shown in FIG. 3, when the transmission synchronization signal V_{ACT} is at the low level at the time t₃ when the acquisition synchronization signal V_{REF} changes from the high level to the low level, further waiting from the time t₃ until the blanking time T₅ has elapsed is performed, and the transmission synchronization signal V_{ACT} is raised at the time t₄. In such a case, because the transmission synchronization signal V_{ACT} is newly synchronized in the state in which the transmission synchronization signal V_{ACT} is at the low level, namely, in the state of being in the blanking period of the LCD display device 402, the displayed image of the LCD display device 402 is not disordered.

Thereby, it is possible to decrease the frequency of performing the synchronizing of the transmission synchronization signal V_{ACT} in the state in which the transmission synchronization signal V_{ACT} is at the high level, i.e. in the state in which the display processing on the LCD display device 402 is in the middle of a frame.

That is, according to an embodiment of the present invention, the synchronization of the acquisition and the transmission of an image can be suitably maintained even if the LCD controller which does not include any memory for images is used. As a result, the disorder of the displayed image owing to the switching of the frame buffers can be prevented. Furthermore, damage or loss of image data can be suppressed.

I should be noted that, in the examples shown in FIGS. 2 and 3, it is suitable to set the blanking time T₂ to a time longer than that from the end of the buffering of image data to the ends of the working processing and the compression processing of the image data similarly to the waiting time T₇. For example, it is suitable to adopt a configuration of receiving a control signal indicating the end of the compression processing for the image data for one frame from the JPEG codec 24 to raise the switching signal V_{SWT} at the time when the control signal is received.

<Second Control Method>

The first control method described above is one forcing the transmission synchronization signal V_{ACT} to perform synchronization with a change of the acquisition synchronization signal V_{REF} irrespective of the situation of the transmission synchronization signal V_{ACT}. In a second control method, the transmission synchronization signal V_{ACT} is synchronized with the acquisition synchronization signal V_{REF} by adjusting the period of the transmission synchronization signal V_{ACT} over a plurality of periods.

That is, in the present embodiment, the switching control circuit 38 is equipped with edge detection circuits which detect change of the acquisition synchronization signal V_{REF} and change of the transmission synchronization signal V_{ACT}, a phase difference counting circuit which acquires the phase difference between the acquisition synchronization signal V_{REF} and the transmission synchronization signal V_{ACT} based on a detection result of the change of the acquisition synchronization signal V_{REF} and the transmission synchronization signal V_{ACT} by the edge detection circuits, and a synchronization signal correction circuit which corrects the phase difference between the acquisition synchronization signal V_{REF} and the transmission synchronization signal V_{ACT} by increasing the blanking period of the transmission synchronization signal V_{ACT} over a plurality of the frames of the transmission synchronization signal V_{ACT} based on the phase difference between the acquisition synchronization signal V_{REF} and the transmission synchronization signal V_{ACT} which has been obtained by the phase difference counting circuit.

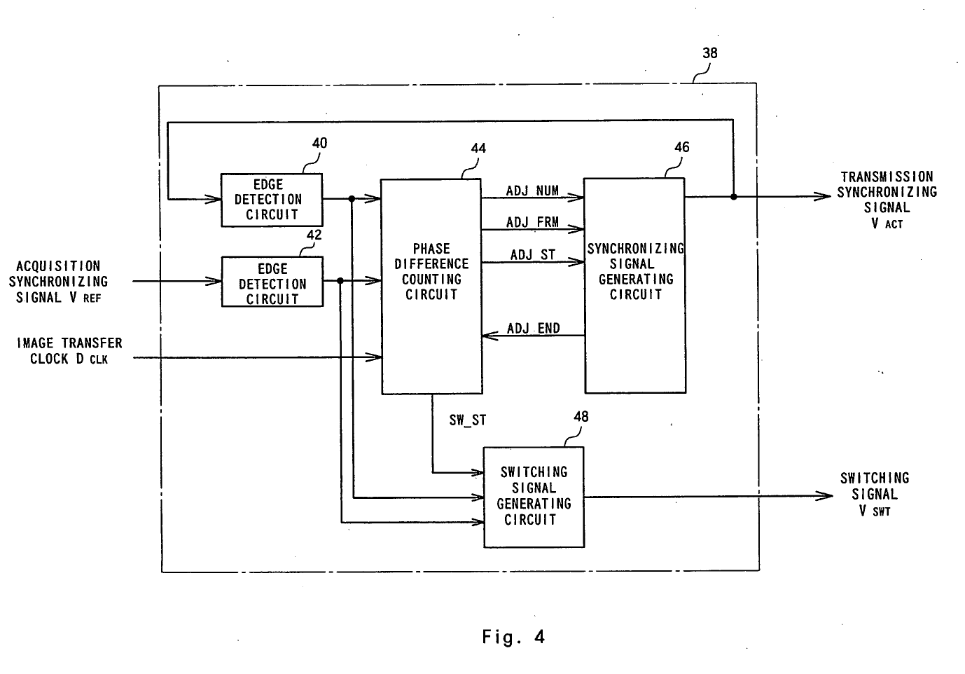

FIG. 4 shows the configuration of the switching control circuit 38 used for the second control method. The switching control circuit 38 is configured to include a first edge detection circuit 40, a second edge detection circuit 42, a phase difference counting circuit 44, a synchronization signal generating circuit 46 and a switching signal generating circuit 48.

Into the first edge detection circuit 40, the transmission synchronization signal V_{ACT} generated by the synchronization signal generating circuit 46 is input by feedback. Into the second edge detection circuit 42, the acquisition synchronization signal V_{REF} is input from the timing generator 36. The edge detection circuits 40 and 42 detect edges indicating a change of the transmission synchronization signal V_{ACT} and a change of the acquisition synchronization signal V_{REF}, respectively. When the edges are detected, detection informing signals are output to the phase difference counting circuit 44 and the switching signal generating circuit 48.

When the phase difference circuit 44 receives the image transfer clock D_{CLK} from the timing generator 36 and the detection informing signals from the first and the second edge detection circuits 40 and 42, the phase difference circuit 44 acquires the phase difference between the acquisition synchronization signal V_{REF} and the transmission synchronization signal V_{ACT} at the time of falling, and outputs a correction clock signal ADJ_NUM, a correction frame signal ADJ_FRM and a correction starting signal ADJ_ST for correcting the phase of the transmission synchronization signal V_{ACT} to the synchronization signal generating circuit 46. Moreover, when the phase difference counting circuit 44 receives a correction end signal ADJ_END indicating the completion of the phase correction of the transmission synchronization signal V_{ACT} from the synchronization signal generating circuit 46, the phase difference counting circuit 44 outputs a switching instruction signal SW_ST to the switching signal generating circuit 48.

The synchronization signal generating circuit 46 generates the transmission synchronization signal V_{ACT} which is output to the LCD I/F 20 and the LCD controller 400. The synchronization signal generating circuit 46 also has a function of correcting the phase of the transmission synchronization signal V_{ACT} when the synchronization signal generating circuit 46 receives the correction clock signal ADJ_NUM, the correction frame signal ADJ_FRM and the correction starting signal ADJ_ST and the phases of the transmission synchronization signal V_{ACT} and the acquisition synchronization signal V_{REF} shift from each other. Moreover, when the switching signal generating circuit 48 receives the switching instruction signal SW_ST and the detection informing signals, the switching signal generating circuit 48 generates and outputs the switching signal V_{SWT} for switching the frame buffer circuits 30 and 32.

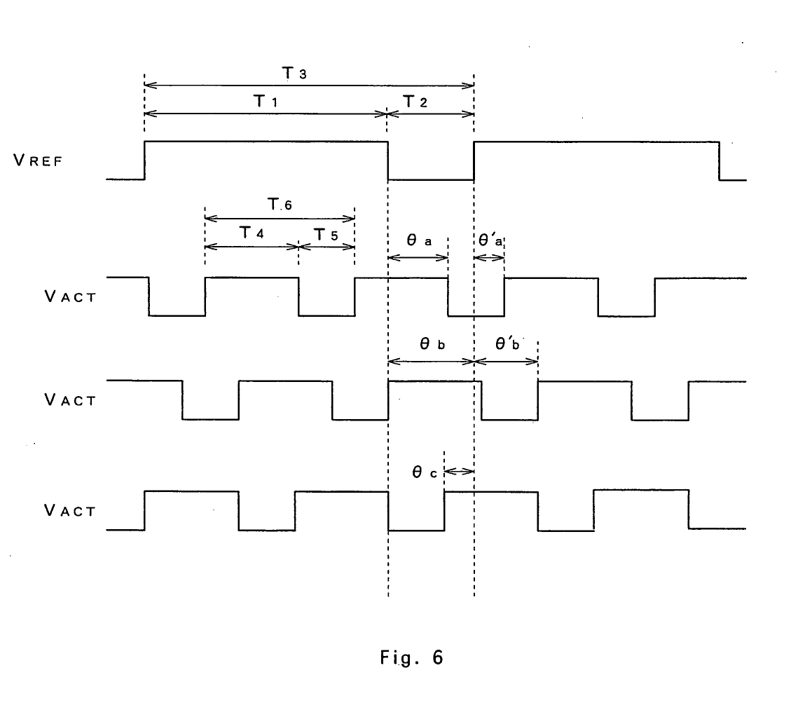

FIG. 6 shows typical relationships when the phases of the acquisition synchronization signal V_{REF} and the transmission synchronization signals V_{ACT} shift from each other. Similarly in the first embodiment, the acquisition synchronization signal V_{REF} is generated by the timing generator 36 in response to a power supply operation, a shutter operation, or the like input to the image capturing device. The acquisition synchronization signal V_{REF} repeats a cycle of maintaining the high level for the predetermined effective period T₁ and after that of maintaining the low level for the predetermined blanking time T₂. That is, the acquisition synchronization signal V_{REF} has the predetermined period T₃ which is a result of the addition of the effective period T₁ and the blanking period T₂. Moreover, the transmission synchronization signal V_{ACT} is normally raised to the high level for a predetermined effective period T₄, and successively lowered to the low level for the predetermined blanking period T₅. The period T₆ of the transmission synchronization signal V_{ACT} is set to be shorter than the period T₃ of the acquisition synchronization signal V_{REF}. Hereupon, the period T₃ of the acquisition synchronization signal V_{REF} is set to be an integral multiple of the period T₆ of the transmission synchronization signal V_{ACT}. More specifically, the period T₃ of the acquisition synchronization signal V_{REF} is set to be two to five times the period T₆ of the transmission synchronization signal V_{ACT}.

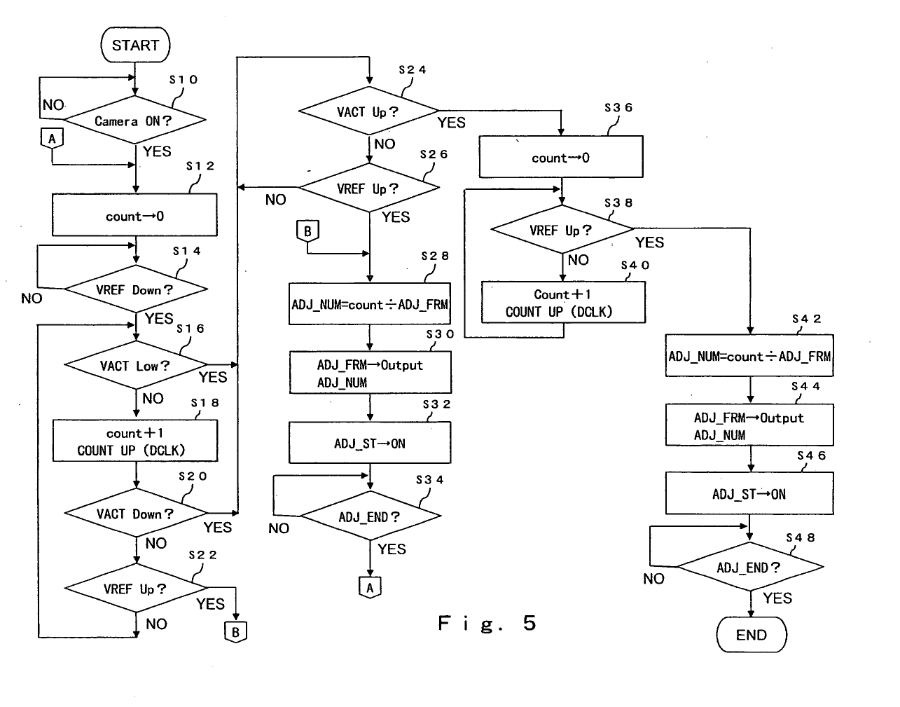

First, with reference to the flowchart of FIG. 5, a method of correcting the phase shift between the transmission synchronization signal V_{ACT} and the acquisition synchronization signal V_{REF} by increasing the blanking period of the transmission synchronization signal V_{ACT} is described. The succeeding processing is executed along the temporal changes of the transmission synchronization signal V_{ACT} and the acquisition synchronization signal V_{REF}.

At Step S10, it is judged whether or not an image capturing instruction from a user is issued. The image capturing instruction concerns, for example, whether the power source of an image capturing device is turned on, or whether the shutter of the image capturing device is depressed. When the image capturing instruction from a user is issued, the CPU 300 outputs an instruction signal to he timing generator 36 to start the output of the acquisition synchronization signal V_{REF}, and causes the processing move to Step S12. When the image capturing instruction is not issued, the processing at Step S10 is repeated.

At Step S12, the counter value indicating the phase shift between the transmission synchronization signal V_{ACT} and the acquisition synchronization signal V_{REF} is initially set to be 0 in the phase difference counting circuit 44. At Step S14, it is judged whether or not the acquisition synchronization signal V_{REF} is at the low level. The acquisition synchronization signal V_{REF} is input to the second edge detection circuit 42 from the timing generator 36, and it is judged whether or not the acquisition synchronization signal V_{REF} has become the low level. When the acquisition synchronization signal V_{REF} has becomes low level, the detection informing signal indicating the detection of the edge is output to the phase difference counting circuit 44 and the switching signal generating circuit 48, and the processing shifts to Step S16. When the acquisition synchronization signal V_{REF} is at the high level, the judgment at Step S14 is repeated.

At Step S16, whether or not the transmission synchronization signal V_{ACT} is at the low level is judged. The transmission synchronization signal V_{ACT} generated by the synchronization signal generating circuit 46 is input into the first edge detection circuit 40 as the feedback, and whether the transmission synchronization signal V_{ACT} is at the low level or not is detected. When the transmission synchronization signal V_{ACT} is at the low level, the processing jumps to Step S24. When the transmission synchronization signal V_{ACT} is at the high level, the processing jumps to Step S18.

At Step S18, the counter value is increased in the phase difference counting circuit 44. When the phase difference counting circuit 44 receives from the second edge detection circuit 42 the detection informing signal indicating that the acquisition synchronization signal V_{REF} has fallen to the low level, the phase difference counting circuit 44 increases the counter value by one in response to one clock pulse of the image transfer clock D_{CLK}. That is, as shown in FIG. 6 as phase differences θa and θb, the counter value becomes a value indicating the time from the time point when the acquisition synchronization signal V_{REF} has fallen to the low level at Step S14. When the image transfer clock D_{CLK} has been counted by a predetermined clock pulse number, for example, one clock pulse, the processing jumps to Step S20.

At Step S20, whether or not the transmission synchronization signal V_{ACT} has become the low level is judged. When the first edge detection circuit 40 receives the feedback input of the transmission synchronization signal V_{ACT}, the first edge detection circuit 40 detects whether or not the transmission synchronization signal V_{ACT} becomes the low level. When the transmission synchronization signal V_{ACT} has become the low level, the detection informing signal indicating the detection of the edge is output to the phase difference counting circuit 44 and the switching signal generating circuit 48, and the processing shifts to Step S24. When the transmission synchronization signal V_{ACT} maintains the high level, the processing jumps to Step S22.

When it is detected that the transmission synchronization signal V_{ACT} has become the low level at Step S20, it is known that the transmission synchronization signal V_{ACT} has become the low level at least once during a period from the time the acquisition synchronization signal V_{REF} became low level to the time the acquisition synchronization signal V_{REF} next became high level, as shown in the second step of FIG. 6. In such case, when the phase difference counting circuit 44 receives the detection informing signal from the first edge detection circuit 40, the phase difference counting circuit 44 stops the increase of the counter value. Consequently, the counter value of the phase difference counting circuit 44 becomes a value indicating a phase difference θa of from the time point when the acquisition synchronization signal V_{REF} has become the low level to the time point when the transmission synchronization signal V_{ACT} has become the low level.

At Step S22, it is judged whether or not the acquisition synchronization signal V_{REF} has become the high level. The second edge detection circuit 42 determines whether or not the acquisition synchronization signal V_{REF} input from the timing generator 36 has become the high level. When the acquisition synchronization signal V_{REF} has become the high level, the detection informing signal indicating the detection of the edge is output to the phase difference counting circuit 44 and the switching signal generating circuit 48, and the processing shifts to Step S28. When the acquisition synchronization signal V_{REF} maintains the low level, the processing returns to Step S16.

Determination that the acquisition synchronization signal V_{REF} is at the high level at Step S22 indicates that the transmission synchronization signal V_{ACT} did not fall to the low level at any time during the period from when the acquisition synchronization signal V_{REF} became the low level to when the acquisition synchronization signal V_{REF} became the high level as shown in the third step of FIG. 6. In such a case, when the phase difference counting circuit 44 receives the detection informing signal from the first edge detection circuit 40, the phase difference counting circuit 44 stops the increase in the counter value. Consequently, the counter value of the phase difference counting circuit 44 becomes a value indicating a phase difference θb of the transmission synchronization signal V_{ACT} from the time point when the acquisition synchronization signal V_{REF} became the low level to the time point when the acquisition synchronization signal V_{REF} became the high level next.

At Step S24, it is judged whether or not the transmission synchronization signal V_{ACT} ha become the high level. When the first edge detection circuit 40 receives the feedback input of the transmission synchronization signal V_{ACT}, the first edge detection circuit 40 determines whether or not the transmission synchronization signal V_{ACT} has become the high level. When the transmission synchronization signal V_{ACT} has become the high level, the detection informing signal indicating the detection of the edge is transmitted from the first edge detection circuit 40 to the phase difference counting circuit 44, and the processing jumps to Step S36. When the transmission synchronization signal V_{ACT} maintains the low level, the processing jumps to Step S26.

A determination that the transmission synchronization signal V_{ACT} has become the high level at Step S24 indicates that the transmission synchronization signal V_{ACT} fell to the low level and then resumed the high level sometime during a period from when the acquisition synchronization signal V_{REF} became the low level to when the acquisition synchronization signal V_{REF} has next became the high level as shown in the fourth step of FIG. 6. In this case, by the processing after Step S36, the phase difference counting circuit 44 measures a phase difference θc of from at the time point when the transmission synchronization signal V_{ACT} became the high level to the time point when the acquisition synchronization signal V_{REF} became the high level. The processing after Step S36 will be described later.

At Step S26, it is judged whether or not the acquisition synchronization signal V_{REF} has become the high level. The second edge detection circuit 42 detects whether or not the acquisition synchronization signal V_{REF} input from the timing generator 36 has become the high level. When the acquisition synchronization signal V_{REF} has become the high level, the detection informing signal indicating the detection of the edge is output to the phase difference counting circuit 44 and the switching signal generating circuit 48, and the processing jumps to Step S28. When the acquisition synchronization signal V_{REF} maintains the low level, the processing returns to Step S24.

At Step S28, the phase correction quantity of the transmission synchronization signal V_{ACT} per frame is calculated as the correction clock signal ADJ_NUM. The phase difference counting circuit 44 calculates the correction clock signal ADJ_NUM by dividing the counter value by the value of a preset correction frame signal ADJ_FRM. The correction frame signal ADJ_FRM is a value indicating the frame number of the transmission synchronization signal V_{ACT} the phase of which is corrected. The correction frame signal ADJ_FRM is normally set within a range of from several frames to several tens of frames.

At Step S30, the correction clock signal ADJ_NUM and the correction frame signal ADJ_FRM are transmitted from the phase difference counting circuit 44 to the synchronization signal generating circuit 46. Successively, at Step S32, the correction starting signal ADJ_ST is transmitted from the phase difference counting circuit 44 to the synchronization signal generating circuit 46, and the phase shift of the transmission synchronization signal V_{ACT} from the phase of the acquisition synchronization signal V_{REF} is corrected by increasing the blanking period in the transmission synchronization signal V_{ACT} of the frame number of the correction frame signal ADJ_FRM by the time indicated by the correction clock signal ADJ_NUM.

For example, when the counter value is 100 and the value of correction frame signal ADJ_FRM is two frames, the phase difference counting circuit 44 calculates the correction clock signal ADJ_NUM as the correction clock signal ADJ_NUM=100÷2=50. When the synchronization signal generating circuit 46 receives the correction starting signal ADJ_ST, the synchronization signal generating circuit 46 performs phase correction processing to increase the blanking period of the transmission synchronization signals V_{ACT} for two frames severally by 50 clocks of the image transfer clock D_{CLK} based on the correction frame signal ADJ_FRM and the correction clock signal ADJ_NUM.

At Step S34, it is judged whether or not the phase correction processing has been completed. When the correction of the phase difference between the transmission synchronization signal V_{ACT} and the acquisition synchronization signal V_{REF} at Step S 32 has been completed, the synchronization signal generating circuit 46 outputs a correction end signal ADJ_END indicating the end of the processing to the phase difference counting circuit 44. When the phase difference counting circuit 44 receives the correction end signal ADJ_END, the phase difference counting circuit 44 outputs the switching instruction signal SW_ST to the switching signal generating circuit 48, and the processing returns to Step S12 to be repeated. When the switching signal generating circuit 48 receives the switching instruction signal SW_ST, the switching signal generating circuit 48 generates the switching signal V_{SWT} for switching the frame buffer circuits 30 and 32, and outputs the generated switching signal V_{SWT} to the switching circuits 34.

At Step S36, in the phase difference counting circuit 44, the counter value indicating the phase shift between the transmission synchronization signal V_{ACT} and the acquisition synchronization signal V_{REF} is initialized to 0. At Step S38, it is judged whether or not the acquisition synchronization signal V_{REF} has become the high level. In the second edge detection circuit 42, it is judged whether or not the acquisition synchronization signal V_{REF} has become the high level. When it is determined that the acquisition synchronization signal V_{REF} has become the high level, the detection informing signal indicating the detection of the edge is output to the phase difference counting circuit 44 and the switching signal generating circuit 48, and the processing shifts to Step S42. When the acquisition synchronization signal V_{REF} maintains the low level, the processing shifts to Step S40.

At Step S40, in the phase difference counting circuit 44, the counter value is increased. When the phase difference counting circuit 44 receives the detection informing signal from the second edge detection circuit 42, the phase difference counting circuit 44 increases the counter value by one in response to a clock pulse of the image transfer clock D_{CLK}. That is, as shown in the fourth step of FIG. 6, the counter value becomes a value indicating the phase difference θc of the transmission synchronization signal V_{ACT} from the time point when the transmission synchronization signal V_{ACT} rose to the high level at Step S24 until the acquisition synchronization signal V_{REF} returns to the high level. When the image transfer clock D_{CLK} has been counted by a predetermined clock pulse numbers, for example, by one clock pulse, the processing shifts to Step S38.

On the other hand, at Steps S42-S48, the same processing as that at Steps S28-S34, which has been described above, is performed. That is, the phase difference counting circuit 44 calculates the correction clock signal ADJ_NUM, and the synchronization signal generating circuit 46 corrects the phase difference between the transmission synchronization signal V_{ACT} and the acquisition synchronization signal V_{REF} based on the correction frame signal ADJ_FRM and the correction clock signal ADJ_NUM. Then, at the time point when the correction processing has ended, the switching signal generating circuit 48 outputs the switching signal V_{SWT} to the switching circuits 34.

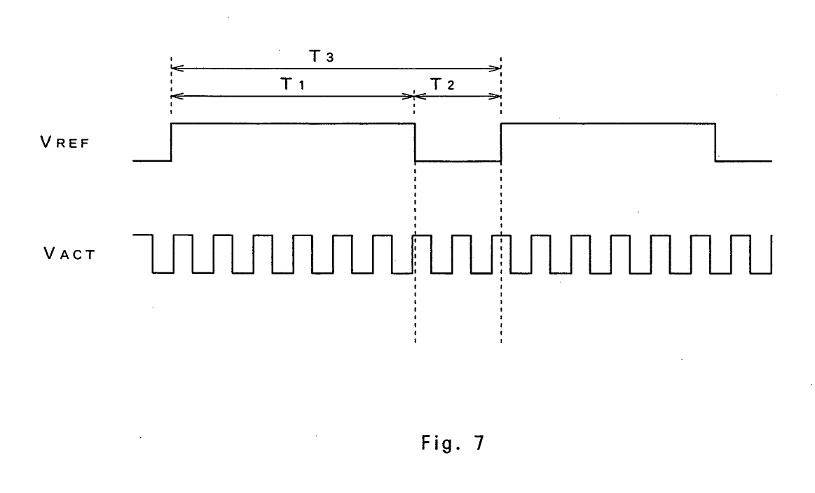

As described above, by performing the correction processing of the present embodiment on occasion, the phase shifts between the transmission synchronization signals V_{ACT} and the acquisition synchronization signal V_{REF} as shown in FIG. 6 can be corrected by increasing the blanking period of the transmission synchronization signal V_{ACT}. Incidentally, even when a plurality of frames of transmission synchronization signal V_{ACT} is included during a period from a time when the acquisition synchronization signal V_{REF} fell to the low level to a time when the acquisition synchronization signal V_{REF} rose to the high level again as shown in FIG. 7, the phase shift between the transmission synchronization signal V_{ACT} and the acquisition synchronization signal V_{REF} can be corrected by the processing described above.

That is, according to this embodiment of the present invention, the synchronization of the acquisition and the transmission of an image can be suitably maintained even if the LCD controller which does not include any memory for images is used. As a result, the disorder of the displayed image owing to the switching of the frame buffers can be prevented. Furthermore, damage or loss of image data can be suppressed.

Moreover, it is suitable to set the blanking time to be longer than a time from the end of the buffering of image data to the ends of the working processing and the compression processing of the image data. Because the phase correction is performed by increasing the blanking time of the transmission synchronization signal V_{ACT} in the present embodiment, it is possible to prevent the switching of the frame buffer circuits 30 and 32 at least before the ends of the working processing and the compression processing of the image data. Here, it is suitable to adopt a configuration of receiving a control signal indicating the end of the compression processing for the image data for one frame from the JPEG codec 24 to raise the transmission synchronization signal V_{ACT} after receiving the control signal.

### MODIFIED EXAMPLE

In the second embodiment, the transmission synchronization signal V_{ACT} is synchronized with the acquisition synchronization signal V_{REF} by increasing the blanking period of the transmission synchronization signal V_{ACT}. In the present modified example, the transmission synchronization signal V_{ACT} is synchronized with the acquisition synchronization signal V_{REF} by increasing and decreasing the blanking period of the transmission synchronization signal V_{ACT}.

That is, in the present modified example, the switching control circuit 38 is equipped with edge detection circuits detecting a change of the acquisition synchronization signal V_{REF} and a change of transmission synchronization signal V_{ACT}, a phase difference counting circuit acquiring a phase difference between the acquisition synchronization signal V_{REF} and the transmission synchronization signal V_{ACT} based on detection results of the changes of the acquisition synchronization signal V_{REF} and the transmission synchronization signal V_{ACT} by the edge detection circuits, and a synchronization signal correcting circuit correcting the phase difference between the acquisition synchronization signal V_{REF} and the transmission synchronization signal V_{ACT} by increasing and decreasing the blanking period of the transmission synchronization signal V_{ACT} over a plurality of frames of the transmission synchronization signal V_{ACT} based on the phase difference between the acquisition synchronization signal V_{REF} and the transmission synchronization signal V_{ACT} which phase difference is obtained by the phase difference counting circuit.

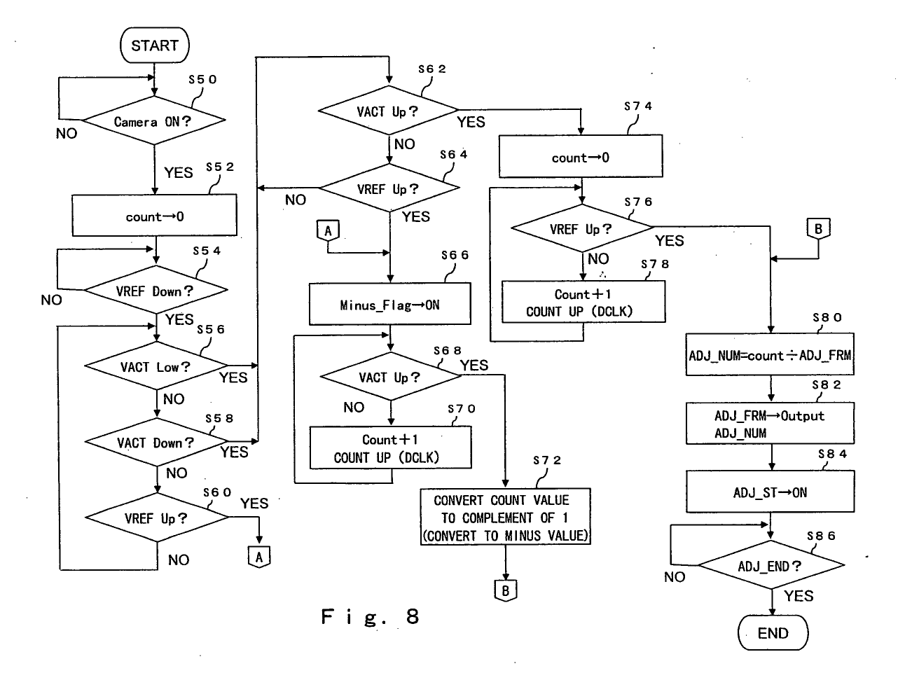

Although the switching control circuit 38 in the present modified example has the same configuration as that of the second embodiment described above, the present modified example differs from the second embodiment in that a flag Minus_Flag is used in the phase difference counting circuit 44. The value of the flag Minus_Flag indicates which the phase correction processing of increasing the blanking period of the transmission synchronization signal V_{ACT} or decreasing the blanking period is performed. The initial setting value of the flag Minus_Flag is “0” indicating increase, and the value of the flag Minus_Flag is set to “1” indicating decrease as the need arises. Hereinafter, with reference to the flowchart of FIG. 8, the phase correction processing of the transmission synchronization signal V_{ACT} and the acquisition synchronization signal V_{REF} in the present modified example is described.

At Step S50, it is judged whether or not an image capturing instruction from a user is issued. The image capturing instruction concerns, for example, whether the power source of an image capturing device is turned on, or whether the shutter of the image capturing device is pushed down. When the image capturing instruction from the user is issued, the CPU 300 outputs an instruction signal to the timing generator 36 to start the outputting of the acquisition synchronization signal V_{REF}, and causes the processing move to Step S52. When the image capturing instruction is not issued, the processing at Step S50 is repeated.

At Step S52, the counter value indicating the phase shift between the transmission synchronization signal V_{ACT} and the acquisition synchronization signal V_{REF} is initialized to be 0 in the phase difference counting circuit 44. At Step S54, whether the acquisition synchronization signal V_{REF} is at the low level or not is judged. The acquisition synchronization signal V_{REF} is input to the second edge detection circuit 42 from the timing generator 36, and whether the acquisition synchronization signal V_{REF} has become the low level or not is judged. When the acquisition synchronization signal V_{REF} has become the low level, a detection informing signal indicating the detection of an edge is output to the phase difference counting circuit 44 and the switching signal generating circuit 48, and the processing shifts to Step S56. When the acquisition synchronization signal V_{REF} is at the high level, the judgment at Step S54 is repeated.

At Step S56, whether or not the transmission synchronization signal V_{ACT} is at the low level is judged. The transmission synchronization signal V_{ACT} generated by the synchronization signal generating circuit 46 is input into the first edge detection circuit 40 as the feedback, and whether the transmission synchronization signal V_{ACT} is at the low level or not is detected. When the transmission synchronization signal V_{ACT} is at the low level, the processing shifts to Step S62. When the transmission synchronization signal V_{ACT} is at the high level, the processing shifts to Step S58.

At Step S58, it is judged whether or not the transmission synchronization signal V_{ACT} has become the low level. When the first edge detection circuit 40 receives the feedback input of the transmission synchronization signal V_{ACT}, the first edge detection circuit 40 detects whether or not the transmission synchronization signal V_{ACT} has become the low level. When the transmission synchronization signal V_{ACT} has become the low level, the detection informing signal indicating the detection of the edge is output to the phase difference counting circuit 44 and the switching signal generating circuit 48, and the processing jumps to Step S62. When the transmission synchronization signal V_{ACT} maintains the high level, the processing jumps to Step S60.

A determination that the transmission synchronization signal V_{ACT} has become the low level at Step S58 indicates that the transmission synchronization signal V_{ACT} dropped to the low level at least once during a period from when the acquisition synchronization signal V_{REF} became the low level to when the acquisition synchronization signal V_{REF} has next became the high level, as shown in the second step of FIG. 6.

At Step S60, it is judged whether or tthe acquisition synchronization signal V_{REF} has become the high level. The second edge detection circuit 42 detects whether the acquisition synchronization signal V_{REF} input from the timing generator 36 has become the high level or not. When the acquisition synchronization signal V_{REF} has become the high level, the detection informing signal indicating the detection of the edge is output to the phase difference counting circuit 44 and the switching signal generating circuit 48, and the processing jumps to Step S66. When the acquisition synchronization signal V_{REF} maintains the low level, the processing returns to Step S56.

A determination that the acquisition synchronization signal V_{REF} is at the high level at Step S60 indicates that the transmission synchronization signal V_{ACT} did not fall to the low level at any time during the period from when the acquisition synchronization signal V_{REF} became the low level to when the acquisition synchronization signal V_{REF} became the high level next as shown in the third step of FIG. 6.

At Step S62, it is judged whether or not the transmission synchronization signal V_{ACT} has become the high level. When the first edge detection circuit 40 receives the feedback input of the transmission synchronization signal V_{ACT}, the first edge detection circuit 40 determines whether or not the transmission synchronization signal V_{ACT} has become the high level. When the transmission synchronization signal V_{ACT} has become the high level, the detection informing signal indicating the detection of the edge is transmitted from the first edge detection circuit 40 to the phase difference counting circuit 44, and the processing jumps to Step S74. When the transmission synchronization signal V_{ACT} maintains the low level, the processing jumps to Step S64.

A determination that the transmission synchronization signal V_{ACT} has become the high level at Step S62 indicates that the transmission synchronization signal V_{ACT} fell to the low level and then resumed the high level sometime during a period from when the acquisition synchronization signal V_{REF} became the low level to when the acquisition synchronization signal V_{REF} has next became the high level as shown in the fourth step of FIG. 6.

At Step S64, it is judged whether or not the acquisition synchronization signal V_{REF} has become the high level. The second edge detection circuit 42 determines whether or not the acquisition synchronization signal V_{REF} input from the timing generator 36 has become the high level. When the acquisition synchronization signal V_{REF} has become the high level, the detection informing signal indicating the detection of the edge is output to the phase difference counting circuit 44 and the switching signal generating circuit 48, and the processing jumps to Step S66. When the acquisition synchronization signal V_{REF} maintains the low level, the processing is returned to Step S62.

At Step S66, the phase difference counting circuit 44 sets the value of the flag Minus_Flag to “1”. That is, in when the transmission synchronization signal V_{ACT} has become the low level after the acquisition synchronization signal V_{REF} has become the low level and before the acquisition synchronization signal V_{REF} become the high level next, and the transmission synchronization signal V_{ACT} maintains the low level until the acquisition synchronization signal V_{REF} becomes the high level next as shown in the second step in FIG. 6, and when the transmission synchronization signal V_{ACT} did not fall to the low level once after the acquisition synchronization signal V_{REF} has become the low level and, before the acquisition synchronization signal V_{REF} becomes the high level as shown in the third step in FIG. 6, the processing of shortening the blanking period of the transmission synchronization signal V_{ACT} is performed.

At Step S68, it is judged whether or not the transmission synchronization signal V_{ACT} has become the high level. When the first edge detection circuit 40 receives the feedback input of the transmission synchronization signal V_{ACT}, the first edge detection circuit 40 determines whether or not the transmission synchronization signal V_{ACT} has become the high level. When the transmission synchronization signal V_{ACT} has become the high level, the detection informing signal of the edge is transmitted from the first edge detection circuit 40 to the phase difference counting circuit 44, and the processing jumps to Step S72. When the transmission synchronization signal V_{ACT} maintains the low level, the processing jumps to Step S70.

At Step S70, the counter value is increased in the phase difference counting circuit 44. The phase difference counting circuit 44 increases the counter value by one in response to a clock pulse of the image transfer clock D_{CLK}. That is, the counter value becomes a value indicating the phase difference θ′a or θ′b during a period between the time point when the acquisition synchronization signal V_{REF} has become the high level at Step S64 and the time point when the transmission synchronization signal V_{ACT} has become the high level at Step S68. When the image transfer clock D_{CLK} has counted a predetermined clock pulse number, for example, by one clock pulse, the processing returns to Step S68.

At Step S72, the counted value is converted to its complement. The phase difference counting circuit 44 determines whether or not the value of the flag Minus_Flag is “1”t. When the value of the flag Minus_Flag is “1”, the phase difference counting circuit 44 converts the counted value to its complement. Therefore, the counted value shows a negative value. After that, the processing jumps to Step S80.

At Step S74, the counter value is initialized to 0. At Step S76, it is judged whether or not the acquisition synchronization signal V_{REF} has become the high level. The second edge detection circuit 42 determines whether or not the acquisition synchronization signal V_{REF} input from the timing generator 36 has become the high level. When the acquisition synchronization signal V_{REF} has become the high level, the detection informing signal indicating the detection of an edge is output to the phase difference counting circuit 44 and the switching signal generating circuit 48, and the processing jumps to Step S80. When the acquisition synchronization signal V_{REF} maintains the low level, the processing jumps to Step S78.

At Step S78, in the phase difference counting circuit 44, the counter value is increased. The phase difference counting circuit 44 increases the counter value by one in response to a clock pulse of the image transfer clock D_{CLK}. That is, the counter value becomes a value indicating the phase difference θc during a period between a time point when the transmission synchronization signal V_{ACT} has become the high level at Step S62 and a time point when the acquisition synchronization signal V_{REF} has become the high level at Step S76 in the situation of the timing chart at the fourth step of FIG. 6. When the image transfer clock D_{CLK} has been counted by a predetermined clock pulse numbers, for example, by one clock pulse, the processing is returned to Step S76.

At Step S80, the phase correction quantity of the transmission synchronization signal V_{ACT} per one frame is calculated as the correction clock signal ADJ_NUM. The phase difference counting circuit 44 calculates the correction clock signal ADJ_NUM by dividing the counter value by the value of the correction frame signal ADJ_FRM. The correction frame signal ADJ_FRM is a value indicating the frame number of the transmission synchronization signal V_{ACT} the phase of which is corrected. The correction frame signal ADJ_FRM is previously set. The correction frame signal ADJ_FRM is normally set within a range of from several frames to several tens of frames. In the present modified example, the correction clock signal ADF_NUM is calculated as a negative value in the case of the second and third charts of FIG. 6, and the correction clock signal ADF_NUM is calculated as a positive value in the case of the fourth chart of FIG. 6.

At Step S82, the correction clock signal ADJ_NUM and the correction frame signal ADJ_FRM are transmitted from the phase difference counting circuit 44 to the synchronization signal generating circuit 46. Successively, at Step S84, a correction starting signal ADJ_ST is transmitted from the phase difference counting circuit 44 to the synchronization signal generating circuit 46, and the phase shift of the transmission synchronization signal V_{ACT} from the phase of the acquisition synchronization signal V_{REF} is corrected by changing the blanking period in the transmission synchronization signal V_{ACT} of the frame number of the correction frame signal ADJ_FRM by the time indicated by the correction clock signal ADJ_NUM. Hereupon, because the correction clock signal ADJ_NUM has been calculated as the negative number in the situations of the timing charts at the second and the third steps of FIG. 6, the phase difference is corrected by shortening the blanking period of the transmission synchronization signal V_{ACT}. On the other hand, because the correction clock signal ADJ_NUM has been calculated as the positive number in the situation of the timing chart at the fourth step of FIG. 6, the phase difference is corrected by increasing the blanking period of the transmission synchronization signal V_{ACT}.

At Step S86, it is judged whether or not the phase correction processing has been completed. When the correction of the phase difference between the transmission synchronization signal V_{ACT} and the acquisition synchronization signal V_{REF} at Step S84 has been completed, the synchronization signal generating circuit 46 outputs the correction end signal ADJ_END indicating the end of the processing to the phase difference counting circuit 44. When the phase difference counting circuit 44 receives the correction end signal ADJ_END, the phase difference counting circuit 44 outputs the switching instruction signal SW_ST to the switching signal generating circuit 48. When the switching signal generating circuit 48 receives the switching instruction signal SW_ST, the switching signal generating circuit 48 generates a switching signal V_{SWT} for switching the frame buffer circuits 30 and 32, and outputs the generated switching signal V_{SWT} to the switching circuit 34.

By performing the correction processing of the present embodiment as described above, the phase shifts between the transmission synchronization signals V_{ACT} and the acquisition synchronization signal V_{REF} as shown in FIG. 6 can be corrected by increasing and decreasing the blanking period of the transmission synchronization signal V_{ACT}.

That is, with the present embodiment of the present invention, the synchronization of the acquisition and the transmission of an image can be suitably maintained, even if an LCD controller which does not include any memory for images is employed. As a result, problems with the displayed image resulting from the switching of the frame buffers can be prevented. Furthermore, damage or loss of image data can be suppressed.

Moreover, the blanking time of the transmission synchronization signal V_{ACT} may be set to be longer than the time from the end of the buffering of image data to the ends of the working processing and the compression processing of the image data. For example, a configuration in which a control signal indicating the end of the compression processing for the image data for one frame is received from the JPEG codec 24 and in which the transmission synchronization signal V_{ACT} is raised after receiving such a control signal may also be adopted.

What is claimed is:

1. An interface device for acquiring an image signal in an effective period of an acquisition synchronization signal having a predetermined period including the effective period and a blanking period in synchronization with the acquisition synchronization signal, and for outputting image data for display in an effective period of a transmission synchronization signal having a period different from that of the acquisition synchronization signal, the different period including the effective period and a blanking period, in synchronization with the transmission synchronization signal, wherein
said interface device acquires a phase difference between the acquisition synchronization signal and the transmission synchronization signal, and corrects the phase difference between the acquisition synchronization signal and the transmission synchronization signal by changing the blanking period of the transmission synchronization signal.

2. The interface device according to claim 1, further comprising:
an edge detection circuit for detecting a change of the acquisition synchronization signal and a change of the transmission synchronization signal;
a phase difference counting circuit for acquiring the phase difference between the acquisition synchronization signal and the transmission synchronization signal based on a detection result of the changes of the acquisition synchronization signal and the transmission synchronization signal in said edge detection circuit; and
a synchronization signal generating circuit for correcting the phase difference between the acquisition synchronization signal and the transmission synchronization signal by increasing and decreasing the blanking period of the transmission synchronization signal over a plurality of frames of the transmission synchronization signal based on the phase difference between the acquisition synchronization signal and the transmission synchronization signal, the phase difference acquired by said phase difference counting circuit.

3. The interface device according to claim 1, further comprising:
an edge detection circuit for detecting a change of the acquisition synchronization signal and a change of the transmission synchronization signal;
a phase difference counting circuit for acquiring the phase difference between the acquisition synchronization signal and the transmission synchronization signal based on a detection result of the changes of the acquisition synchronization signal and the transmission synchronization signal in said edge detection circuit; and
a synchronization signal generating circuit for correcting the phase difference between the acquisition synchronization signal and the transmission synchronization signal by increasing the blanking period of the transmission synchronization signal over a plurality of frames of the transmission synchronization signal based on the phase difference between the acquisition synchronization signal and the transmission synchronization signal, the phase difference acquired by said phase difference counting circuit.

4. An interface device for acquiring an image signal in an effective period of an acquisition synchronization signal having a predetermined period including the effective period and a blanking period in synchronization with the acquisition synchronization signal, and for outputting image data for display in an effective period of a transmission synchronization signal having a period different from that of the acquisition synchronization signal, the different period including the effective period and a blanking period, in synchronization with the transmission synchronization signal, wherein
said interface device starts the blanking period of the transmission synchronization signal, the blanking period of the transmission synchronization signal being for a predetermined time, at an end point of the effective period of the acquisition synchronization signal.

5. An interface device for acquiring an image signal in an effective period of an acquisition synchronization signal having a predetermined period including the effective period and a blanking period in synchronization with the acquisition synchronization signal, and for outputting image data for display in an effective period of a transmission synchronization signal having a period different from that of the acquisition synchronization signal, the different period including the effective period and a blanking period, in synchronization with the transmission synchronization signal, wherein
judges whether the effective period of the transmission synchronization signal ends during a predetermined waiting time from an end point of the effective period of the acquisition synchronization signal, and
starts the blanking period of the transmission synchronization signal, the blanking period of the transmission synchronization signal being for a predetermined time, when the effective period of the transmission synchronization signal does not end within the waiting time.

6. The interface device according to claim 1, further comprising:
a plurality of frame buffer circuits each having a memory capacity for holding image data for at least one frame;
a switching circuit for switching the plurality of frame buffer circuits as a frame buffer circuit buffering the acquired image signal as the image data, or as a frame buffer circuit outputting held image data as the image data for display; and
a switching control circuit for outputting a switching signal to said switching circuit to perform switching control of said switching circuit based on the switching signal, wherein
said switching control circuit outputs the switching signal during the blanking periods of the transmission synchronization signal and the acquisition synchronization signal.

7. The interface device according to claim 4, further comprising:
a plurality of frame buffer circuits each having a memory capacity for holding image data for at least one frame;
a switching circuit for switching the plurality of frame buffer circuits as a frame buffer circuit buffering the acquired image signal as the image data, or as a frame buffer circuit outputting held image data as the image data for display; and
a switching control circuit for outputting a switching signal to said switching circuit to perform switching control of said switching circuit based on the switching signal, wherein
said switching control circuit outputs the switching signal during the blanking periods of the transmission synchronization signal and the acquisition synchronization signal.

8. The interface device according to claim 5, further comprising:
a plurality of frame buffer circuits each having a memory capacity for holding image data for at least one frame;
a switching circuit for switching the plurality of frame buffer circuits as a frame buffer circuit buffering the acquired image signal as the image data, or as a frame buffer circuit outputting held image data as the image data for display; and
a switching control circuit for outputting a switching signal to said switching circuit to perform switching control of said switching circuit based on the switching signal, wherein
said switching control circuit outputs the switching signal during the blanking periods of the transmission synchronization signal and the acquisition synchronization signal.

9. The interface device according to claim 6, wherein said switching control circuit outputs the switching signal after a predetermined waiting time has elapsed subsequent to a start of the blanking period of the acquisition synchronization signal.

10. The interface device according to claim 7, wherein said switching control circuit outputs the switching signal after a predetermined waiting time has elapsed subsequent to a start of the blanking period of the acquisition synchronization signal.

11. The interface device according to claim 8, wherein said switching control circuit outputs the switching signal after a predetermined waiting time has elapsed subsequent to a start of the blanking period of the acquisition synchronization signal.

12. A synchronization adjustment method in interface device for acquiring an image signal in an effective period of an acquisition synchronization signal having a predetermined period including the effective period and a blanking period in synchronization with the acquisition synchronization signal, and for outputting image data for display in an effective period of a transmission synchronization signal having a period different from that of the acquisition synchronization signal, the different period including the effective period and a blanking period, in synchronization with the transmission synchronization signal, said method comprising a first step of correcting a phase difference between the acquisition synchronization signal and the transmission synchronization signal by changing the blanking period of the transmission synchronization signal.

13. The synchronization adjustment method according to claim 12, further comprising:
a second step of detecting a change of the acquisition synchronization signal and a change of the transmission synchronization signal; and
a third step of acquiring the phase difference between the acquisition synchronization signal and the transmission synchronization signal based on a detection result of the changes of the acquisition synchronization signal and the transmission synchronization signal in said second step; wherein
said first step corrects the phase difference between the acquisition synchronization signal and the transmission synchronization signal by increasing the blanking period of the transmission synchronization signal over a plurality of frames of the transmission synchronization signal based on the phase difference between the acquisition synchronization signal and the transmission synchronization signal, the phase difference acquired at said third step.

14. The synchronization adjustment method according to claim 12, further comprising:
a second step of detecting a change of the acquisition synchronization signal and a change of the transmission synchronization signal; and
a third step of acquiring the phase difference between the acquisition synchronization signal and the transmission synchronization signal based on a detection result of the changes of the acquisition synchronization signal and the transmission synchronization signal in said second step; wherein
said first step corrects the phase difference between the acquisition synchronization signal and the transmission synchronization signal by increasing and decreasing the blanking period of the transmission synchronization signal over a plurality of frames of the transmission synchronization signal based on the phase difference between the acquisition synchronization signal and the transmission synchronization signal, the phase difference acquired at said third step.

15. A synchronization adjustment method in interface device for acquiring an image signal in an effective period of an acquisition synchronization signal having a predetermined period including the effective period and a blanking period in synchronization with the acquisition synchronization signal, and for outputting image data for display in an effective period of a transmission synchronization signal having a period different from that of the acquisition synchronization signal, the different period including the effective period and a blanking period, in synchronization with the transmission synchronization signal, wherein
said method starts the blanking period of the transmission synchronization signal, the blanking period of the transmission synchronization signal being for a predetermined time, at an endpoint of the effective period of the acquisition synchronization signal.

16. A synchronization adjustment method in interface device for acquiring an image signal in an effective period of an acquisition synchronization signal having a predetermined period including the effective period and a blanking period in synchronization with the acquisition synchronization signal, and for outputting image data for display in an effective period of a transmission synchronization signal having a period different from that of the acquisition synchronization signal, the different period including an effective period and a blanking period, in synchronization with the transmission synchronization signal, wherein
said method judges whether the effective period of the transmission synchronization signal ends during a predetermined waiting time from an end point of the effective period of the acquisition synchronization signal, and starts the blanking period of the transmission synchronization signal, the blanking period of the transmission synchronization signal being for a predetermined time, when the effective period of the transmission synchronization signal does not end within the waiting time.
